(19) United States
(12) Patent Application Publication
(10) Pub. No.: US 2014/0179371 A1
(43) Pub. Date: Jun. 26, 2014

(54) Electronic Camera Comprising Mobile Phone Apparatus

(71) Applicant: Somasundaram Ramkumar, Madurai (IN)

(72) Inventor: Somasundaram Ramkumar, Madurai (IN)

(21) Appl. No.: 14/102,678

(22) Filed: Dec. 11, 2013

(30) Foreign Application Priority Data
Dec. 12, 2012 (IN) 5169/CHE/2012

(51) Int. Cl. H04B 1/38; H04M 1/02

(52) U.S. Cl. CPC H04B 1/3816; H04M 1/0264; H04M 1/0274
USPC 455/556.1

(57) ABSTRACT

A Camera, Digital Camera, Camcorder, Video Camera and other camera system comprising a mobile phone having one or plurality of simsocket contains plurality of pins wherein Input/Output pin, clock pin, reset pin, vcc pin, ground pin are several respective pins of the said simsocket and the said pins of one or plurality of simsocket are connected in parallel and the said plurality of simsocket for accepting plurality of simcards in order to operate selectively and/or simultaneously, and the said plurality of simsocket are connected to the CPU (Central Processing Unit) (14) in parallel and the said CPU (14) having the switching circuit and the said CPU (14) is connected to the one or plurality of simsocket through switching circuit and the function of one or plurality of simsocket is operated by the CPU (Central Processing Unit) (14), switching circuit, transreceivers (15).

The invention relates to Camera, Digital Camera, Camcorder and Video Camera in particular. The object of the invention is a Camera, Digital Camera, Camcorder, Video Camera and other camera system comprising a mobile phone having one or plurality of simsocket contains plurality of pins wherein Input/Output pin, clock pin, reset pin, vcc pin, ground pin are several respective pins of the said simsocket and the said pins of one or plurality of simsocket are connected in parallel and the said plurality of simsocket for accepting plurality of simcards in order to operate selectively and/or simultaneously, and the said plurality of simsocket are connected to the CPU (Central Processing Unit) (14) in parallel and the said CPU (14) having the switching circuit and the said CPU (14) is connected to the one or plurality of simsocket through switching circuit and the function of one or plurality of simsocket is operated by the CPU (Central Processing Unit) (14), switching circuit, transreceivers (15) and the circuitry of the Camera, Digital Camera, Camcorder and Video Camera is modified in order to accommodate utilization of one simsocket or plurality of simsocket for accepting one simcard or plurality of simcard can transreceive the mobile towers and the function of mobile phone and Camera or Digital Camera or Camcorder or Video Camera is operated by selectively and/or simultaneously by the CPU (Central Processing Unit) (14), switching circuit, transreceivers (15) and the said CPU (14) is connected to the transreceivers (15) through antenna (16) in the Camera, Digital Camera, Camcorder and Video Camera and all the features of mobile phone can operated by CPU (14) in the Camera, Digital Camera, Camcorder and Video Camera and the said features of mobile phone is plurality of bluetooth, plurality of speakers, Wi-fi, SMS, MMS, Video Call, RAM, ROM, Keyboard and/or Virtual Keyboard, plurality of memory socket, Radio, GPS, plurality of memory chips, plurality of camera lens, Television, plurality of antenna and so on can operated by CPU (14) in the Camera, Digital Camera, Camcorder and Video Camera and the said CPU (14) can be plurality of CPU (14) in the Camera, Digital Camera, Camcorder and Video Camera. The said mobile phone can GSM, CDMA and so on. The said mobile phone can 2G (Second Generation), 3G (Third Generation), 4G (Fourth Generation), 5G (Fifth Generation), 6G (Sixth Generation) and so on. In order to incorporate this principle there is a need for technological changes in the existing Camera, Digital Camera, Camcorder and Video Camera. Therefore the entire circuitry of the known Camera, Digital Camera, Camcorder and Video camera is changed.

It is the primary object of invention is a Camera, Digital Camera, Camcorder, Video Camera and other camera system comprising a mobile phone having one or plurality of simsocket contains plurality of pins wherein Input/Output pin, clock pin, reset pin, vcc pin, ground pin are several respective pins of the said simsocket and the said pins of one or plurality of simsocket are connected in parallel and the said plurality of simsocket for accepting plurality of simcards in order to operate selectively and/or simultaneously, and the said plurality of simsocket are connected to the CPU (Central Processing Unit) (14) in parallel and the said CPU (14) having the switching circuit and the said CPU (14) is connected to the one or plurality of simsocket through switching circuit and the function of one or plurality of simsocket is operated by the CPU (Central Processing Unit) (14), switching circuit, transreceivers (15) and the circuitry of the Camera, Digital Camera, Camcorder and Video Camera is modified in order to accommodate utilization of one simsocket or plurality of simsocket for accepting one simcard or plurality of simcard can transreceive the mobile towers and the function of mobile phone and Camera or Digital Camera or Camcorder or Video Camera is operated by selectively and/or simultaneously by the CPU (Central Processing Unit) (14), switching circuit, transreceivers (15) and the said CPU (14) is connected to the transreceivers (15) through antenna (16) in the Camera, Digital Camera, Camcorder and Video Camera and all the features of mobile phone can operated by CPU (14) in the Camera, Digital Camera, Camcorder and Video Camera and the said features of mobile phone is plurality of Bluetooth, plurality of speakers, Wi-fi, SMS, MMS, Video Call, RAM, ROM, Keyboard and/or Virtual Keyboard, plurality of memory socket, Radio, GPS, plurality of memory chips, plurality of camera lens, Television, plurality of antenna and so on can operated by CPU (14) in the Camera, Digital Camera, Camcorder and Video Camera and the said CPU (14) can be plurality of CPU (14) in the Camera, Digital Camera, Camcorder and Video Camera.

The specialty of the invention is a Camera, Digital Camera, Camcorder, Video Camera and other camera system comprising a mobile phone having one or plurality of simsocket contains plurality of pins wherein Input/Output pin, clock pin, reset pin, vcc pin, ground pin are several respective pins of the said simsocket and the said pins of one or plurality of simsocket are connected in parallel and the said plurality of simsocket for accepting plurality of simcards in order to operate selectively and/or simultaneously, and the said plurality of simsocket are connected to the CPU (Central Processing Unit) (14) in parallel and the said CPU (14) having the switching circuit and the said CPU (14) is connected to the one or plurality of simsocket through switching circuit and the function of one or plurality of simsocket is operated by the CPU (Central Processing Unit) (14), switching circuit, transreceivers (15) and the circuitry of the Camera, Digital Camera, Camcorder and Video Camera is modified in order to accommodate utilization of one simsocket or plurality of simsocket for accepting one simcard or plurality of simcard can transreceive the mobile towers and the function of mobile phone and Camera or Digital Camera or Camcorder or Video Camera is operated by selectively and/or simultaneously by the CPU (Central Processing Unit) (14), switching circuit, transreceivers (15) and the said CPU (14) is connected to the transreceivers (15) through antenna (16) in the Camera, Digital Camera, Camcorder and Video Camera and all the features of mobile phone can operated by CPU (14) in the Camera, Digital Camera, Camcorder and Video Camera and the said features of mobile phone is plurality of bluetooth, plurality of speakers, Wi-fi, SMS, MMS, Video Call, RAM, ROM, Keyboard and/or Virtual Keyboard, plurality of memory socket, Radio, GPS, plurality of memory chips, plurality of camera lens, Television, plurality of antenna and so on can operated by CPU (14) in the Camera, Digital Camera, Camcorder and Video Camera and the said CPU (14) can be plurality of CPU (14) in the Camera, Digital Camera, Camcorder and Video Camera.

Now the invention is clear from the following description. The nature of the invention and the manner in which it is to be performed clearly and fully described in the following pages of description.

The salient features of the invention is described in detail with reference to various figures showing essential aspects of the invention.

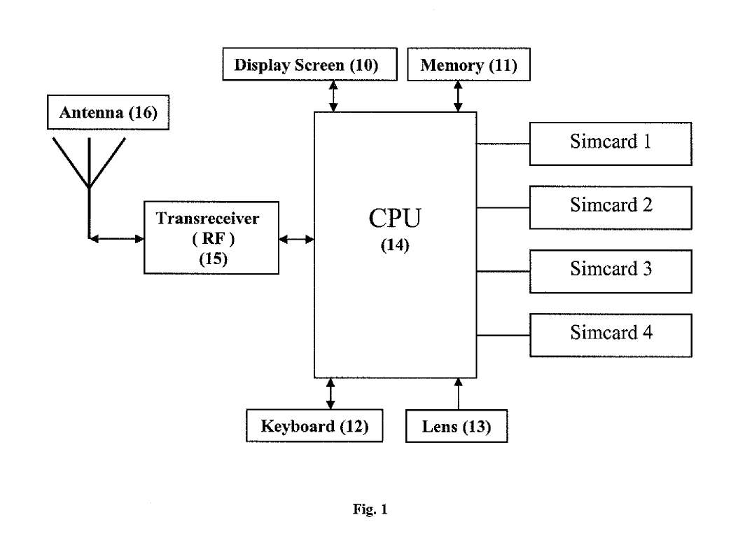

FIG. 1 shows the schematic diagram of the Camera, Digital Camera, Camcorder and Video Camera.

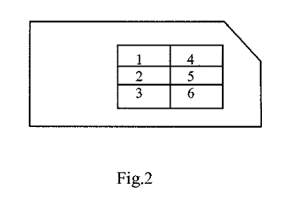

FIG. 2 shows the details of the pins of simcard.

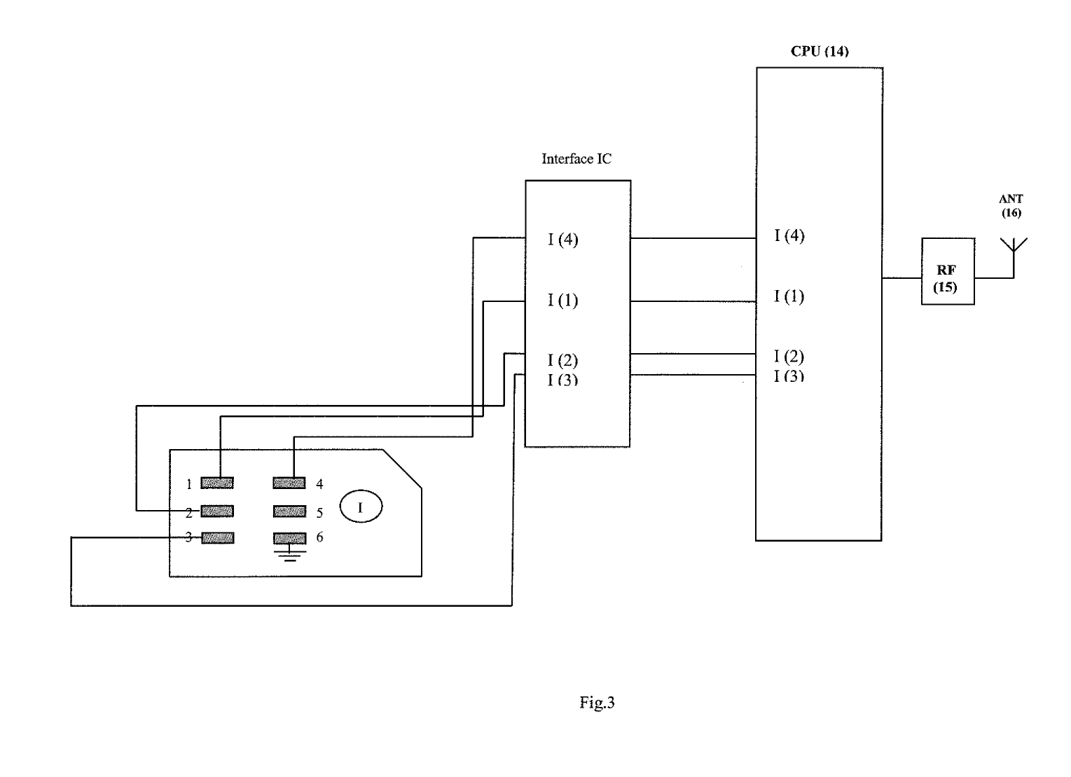

FIG. 3 show the circuitry of the system having one simcard.

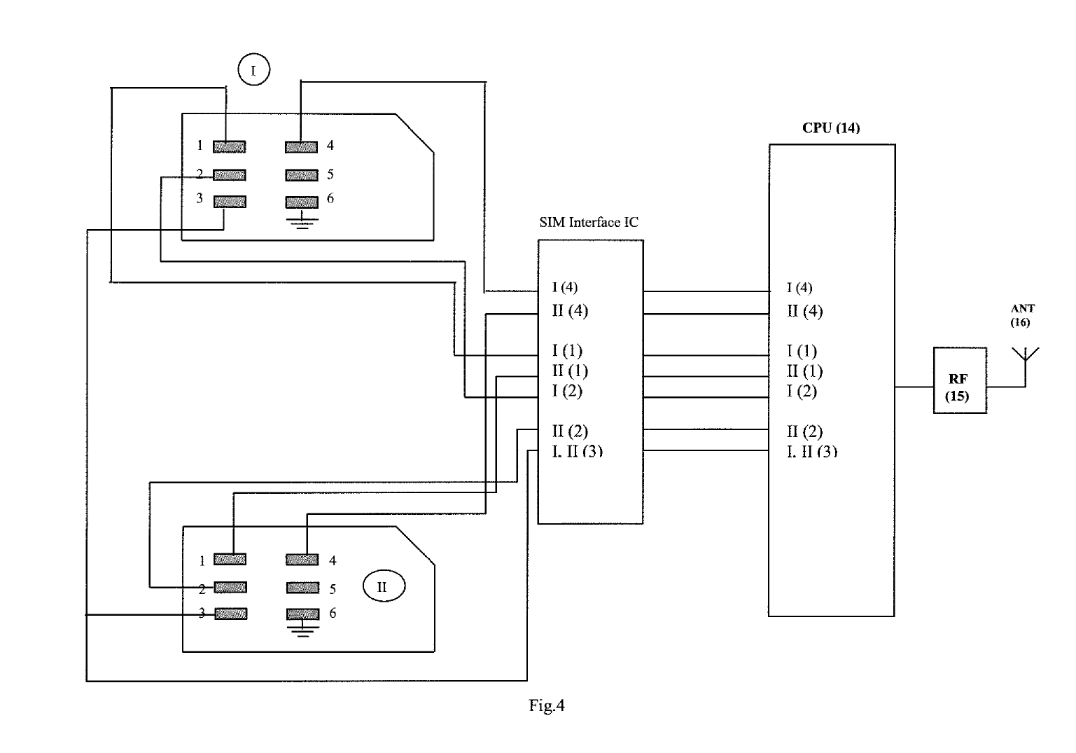

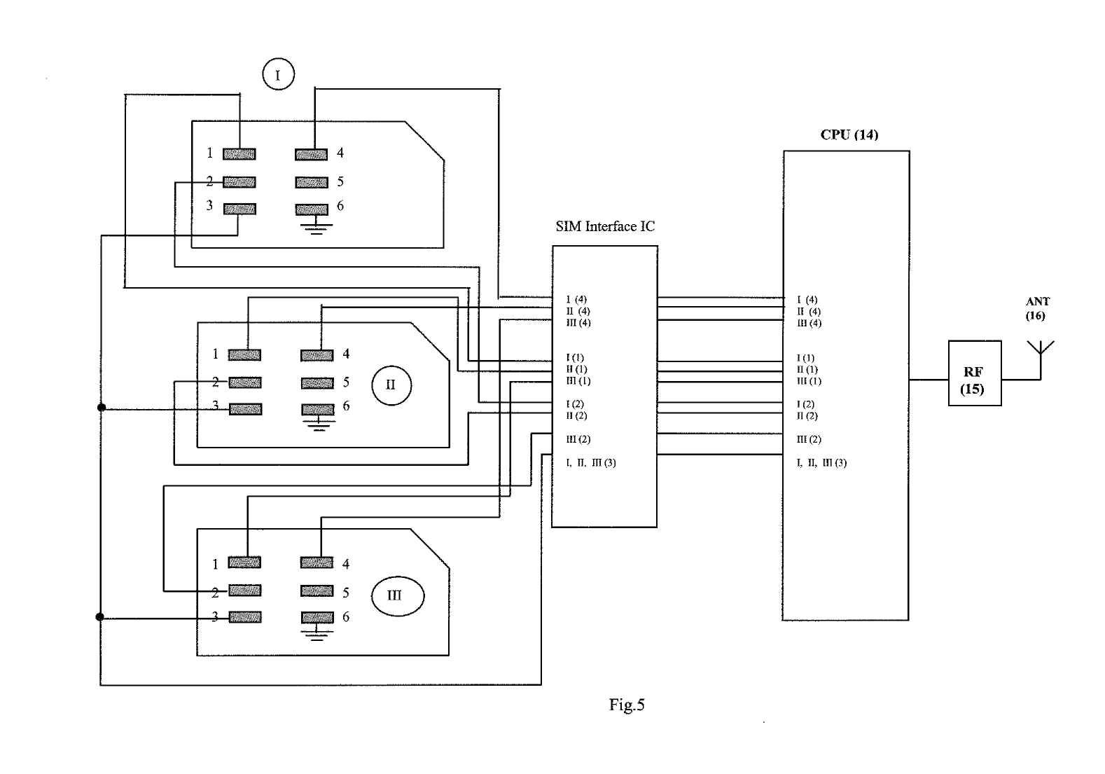

FIG. 4 show the circuitry of the system having two simcards.

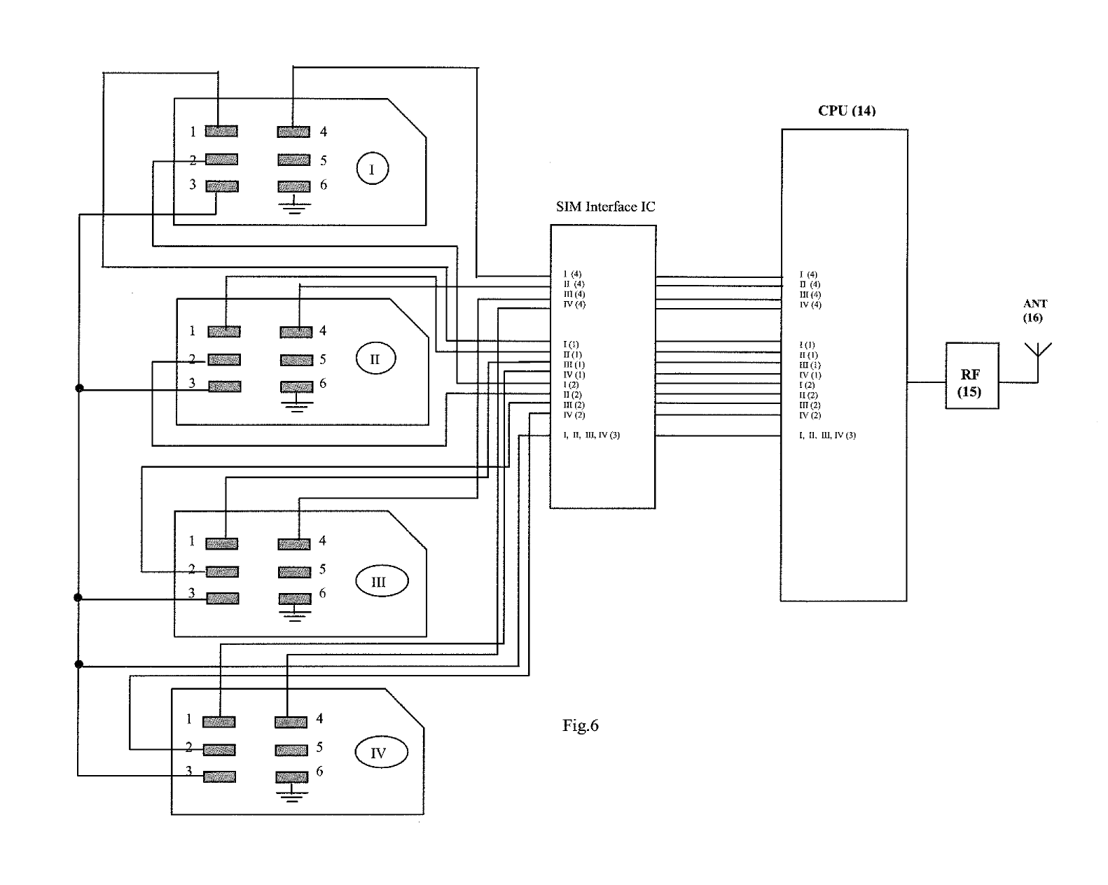

FIG. 5, 6 show the circuitry of the system having multiple simcards.

The Camera, Digital Camera, Camcorder and Video Camera comprising a mobile phone contains Display Screen (10), Keyboard (12) and/or Virtual Keyboard (12), Lens (13), Memory (11), CPU (14), Transreceiver (15), Antenna (16), Simcards and it is shown in the FIG. 1.

The Display Screen (10) is connected to the CPU (Central Processing Unit) (14) for display the characters (or) messages, pictures, videos in a Camera, Digital Camera, Camcorder and Video Camera. The Display screen (10) can be LCD (Liquid Crystal Display), LED (Light Emitting Diode) display screen and so on. The Display Screen (10) is also used for displaying the Caller ID numbers. The menu is shown to the user in words (alphabets, numbers) or abbreviations on the Display Screen (10). Therefore the Display Screen (10) is used for displaying the characters (or) messages, pictures, videos, Menu, the SMS, the MMS, the FAX, the E-mails, Dialing the phone numbers, using the alphabets and abbreviations and so on in a Camera, Digital Camera, Camcorder and Video Camera.

The Keyboard (12) and/or Virtual Keyboard (12) is connected to the CPU (Central Processing Unit) (14) for inputting data like letters and numbers. The Keyboard (12) and/or Virtual Keyboard (12) in the Camera, Digital Camera, Camcorder and Video Camera has keys from numbers ‘0’ to ‘9’ and also the keys have the alphabets from ‘a’ to ‘z’, eg: the key with no. 2 has also the alphabets ‘a, b, c’, the key with no. 3 has also the alphabets ‘d, e, f’ and so on. Based on these arrangements of the keys in the Keyboard and/or Virtual Keyboard (12), the user has the facility either to dial any mobile or telephone number by operating the relevant keys on the Keyboard and/or Virtual Keyboard (12) or send SMS, MMS, FAX, E-mail by pressing a key, eg: ‘m’ to enter into the menu.

The Lens (13) in a Camera, Digital Camera, Camcorder and Video Camera can be designed suitably and can incorporated in any convenient part of Camera, Digital Camera, Camcorder and Video Camera. The operation of the lens (13) of the Camera, Digital Camera, Camcorder and Video Camera is provided by appropriate keys in the Camera, Digital Camera, Camcorder and Video Camera. The Lens (13) of Camera, Digital Camera, Camcorder and Video Camera is connected to the Central Processing Unit (CPU) (14) in the Camera, Digital Camera, Camcorder and Video Camera. The CPU (14) that sends/receives of commands/signals for the lens (13) of the Camera, Digital Camera, Camcorder and Video Camera in a Camera, Digital Camera, Camcorder and Video Camera. The CPU (14) is used to control the operation of the device. The CPU (14) has several input and output pins for the functions of Camera, Digital Camera, Camcorder and Video Camera. The CPU (14) send the commands to operate the Camera, Digital Camera, Camcorder and Video Camera. The Lens (13) in a Camera, Digital Camera, Camcorder and Video Camera to capture the perfect clear object. The lens (13) in a Camera, Digital Camera, Camcorder and Video Camera can be manually operated and/or automatically operated to capture the perfect clear object. The object can be at any distance.

The Memory (11) is connected to the CPU (Central Processing Unit) (14) and the memory (11) can be read and write the messages and for storing information. The programme instructions for operating the facilities in a Camera, Digital Camera, Camcorder and Video Camera are stored in a memory device which is connected to the CPU (Central Processing Unit) (14). The menu can be selected by pressing appropriate keys on the Keyboard and/or Virtual Keyboard and the related instructions of the programme can be stored in the memory (11), to be viewed on the Display Screen (10). The menu is shown to the user in words (alphabets, numbers) or abbreviations on the display screen (10).

The CPU (Central Processing Unit) (14) is used to control the operation of the device. The CPU (14) can also be plurality of CPU (14) is used to control the operation of the device. The simcards are connected in parallel and it is fed to the CPU (14) separately as shown in the FIG. 1. An Antenna (16) and Transreceiver (15) is connected to the CPU (14).

The Transreceivers (RF) (15) are designed, suitable for transreceiving the mobile signals by selectively and/or simultaneously.

The audio of the mobile phone can be heard through speakers and/or headphone/earphone jack and/or bluetooth in a Camera, Digital Camera, Camcorder and Video Camera.

The plurality of bluetooth, plurality of speakers, Wi-fi, SMS, MMS, Video Call, RAM, ROM, Keyboard and/or Virtual Keyboard, plurality of memory socket, Radio, GPS, plurality of memory chips, plurality of camera lens, Television, plurality of antenna are operated by CPU (14) in the Camera, Digital Camera, Camcorder and Video Camera. All the features of mobile phone can operated by CPU (14) in the Camera, Digital Camera, Camcorder and Video Camera and the said features of mobile phone is plurality of bluetooth, plurality of speakers, Wi-fi, SMS, MMS, Video Call, RAM, ROM, Keyboard and/or Virtual Keyboard, plurality of memory socket, Radio, GPS, plurality of memory chips, plurality of camera lens, Television, plurality of antenna and so on can operated by CPU (14) in the Camera, Digital Camera, Camcorder and Video Camera. The Plurality can be one or more than one. The CPU (14) can also be plurality of CPU (14) in the Camera, Digital Camera, Camcorder and Video Camera.

The SIM (Subscriber Indentity Module) having six pins as shown in the FIG. 2. In particular the simcards are connected in parallel. The pin details are as following,
1) CLOCK
2) RESET
3) Vcc
4) I/O (DATA)
5) NC (NO CONNECTION)
6) GROUND

The FIG. 3, 4, 5, 6 having Sim Cards, Sim IC or Sim Interface IC, CPU (14), RF (15) and Antenna (ANT) (16) and it is shown in the figure.

1) The power supply for the sims are the same and therefore the power supply (Vcc) is common to all the sims. The Vcc of individual sims are interconnected before it is fed to the Interface IC as shown in the FIG. 3, 4, 5, 6). The pin (6) having ground and ground pin of individual sims are interconnected and it is earthed. The pin (5) having no connection (NC). The clock signal from the individual sims (simcard I, simcard II and so on) are connected to the sim interface IC seperatly (clk 1, clk 2 etc.,). Then the Input/Output (I/O) data and Reset output from the pins 2 & 4 of the simcard I, simcard II and so on are also fed to the sim interface IC seperatly as shown in the figure (No. 3, 4, 5, 6). Then the signals are fed to the central processing unit (CPU) (14) from the sim interface IC. The CPU (14) is connected to the transreceivers (RF) (15) through Antenna (ANT) (16).

The transreceivers (RF) (15) are designed, suitable for transreceiving plurality of mobile towers by selectively and/or simultaneously.

2) The switching circuit can be placed between the sim interface IC and the CPU (14) (or) the switching circuit also can be a ‘chip’ (i.e.,) Integrated Circuit device (IC) can be placed between the simcards and CPU (14). The timing of switching may be milliseconds, nanoseconds and so on. By this method of switching among multiple number of simcards, multiple number of mobile companies towers can be transreceived through RF (15). Also the switching circuit can be placed between CPU (14) and RF (15), if necessary and multiple number of mobile companies towers can transrecieved. But the timing of switching should be same between the switching of RF (14) and Simcard.

A Camera, Digital Camera, Camcorder, Video Camera and other camera system comprising a mobile phone having one or plurality of simsocket contains plurality of pins wherein Input/Output pin, clock pin, reset pin, vcc pin, ground pin are several respective pins of the said simsocket and the said pins of one or plurality of simsocket are connected in parallel and the said plurality of simsocket for accepting plurality of simcards in order to operate selectively and/or simultaneously, and the said plurality of simsocket are connected to the CPU (Central Processing Unit) (14) in parallel and the said CPU (14) having the switching circuit and the said CPU (14) is connected to the one or plurality of simsocket through switching circuit and the function of one or plurality of simsocket is operated by the CPU (Central Processing Unit) (14), switching circuit, transreceivers (15).

The circuitry of the Camera, Digital Camera, Camcorder and Video Camera is modified in order to accommodate utilization of one simsocket or plurality of simsocket for accepting one simcard or plurality of simcard can transreceive the mobile towers. The function of mobile phone and Camera or Digital Camera or Camcorder or Video Camera is operated by selectively and/or simultaneously by the CPU (Central Processing Unit) (14), switching circuit, transreceivers (15) and the said CPU (14) is connected to the transreceivers (15) through antenna (16) in the Camera, Digital Camera, Camcorder and Video Camera.

If one simcard is provided in the Camera, Digital Camera, Camcorder and Video Camera, then the Camera, Digital Camera, Camcorder and Video Camera can communicate one mobile tower of mobile service provider. If two simcards are provided in the Camera, Digital Camera, Camcorder and Video Camera, then the Camera, Digital Camera, Camcorder and Video Camera can communicate two mobile towers of mobile service providers. If three simcards are provided in the Camera, Digital Camera, Camcorder and Video Camera, then the Camera, Digital Camera, Camcorder and Video Camera can communicate three mobile towers of mobile service providers and so on. Therefore the Camera, Digital Camera, Camcorder and Video Camera can communicate multiple number of mobile towers of mobile service providers depending on multiple number of simcards are provided in the Camera, Digital Camera, Camcorder and Video Camera.

I claim:

1) A Camera, Digital Camera, Camcorder, Video Camera and other camera system comprising a mobile phone, wherein,
a) the said mobile phone having one or plurality of simsocket contains plurality of pins wherein Input/Output pin, clock pin, reset pin, vcc pin, ground pin are several respective pins of the said simsocket and the said pins of one or plurality of simsocket are connected in parallel and the said plurality of simsocket for accepting plurality of simcards in order to operate selectively and/or simultaneously, and the said plurality of simsocket are connected to the CPU (Central Processing Unit) (14) in parallel and the said CPU (14) having the switching circuit and the said CPU (14) is connected to the one or plurality of simsocket through switching circuit,
b) the function of one or plurality of simsocket is operated by the CPU (Central Processing Unit) (14), switching circuit, and transreceivers (15),
c) the circuitry of the Camera, Digital Camera, Camcorder and Video Camera contains one simsocket or plurality of simsocket for accepting one simcard or plurality of simcard can transreceive the mobile towers,
d) the function of mobile phone and Camera or Digital Camera or Camcorder or Video Camera is operated by selectively and/or simultaneously by the CPU (Central Processing Unit) (14), switching circuit, transreceivers (15) and the said CPU (14) is connected to the transreceivers (15) through antenna (16) in the Camera, Digital Camera, Camcorder and Video Camera,
e) the said CPU (14) can plurality of CPU (14) in the Camera, Digital Camera, Camcorder and Video Camera and,
f) the features of mobile phone is plurality of bluetooth, plurality of speakers, Wi-fi, SMS, MMS, Video Call, RAM, ROM, Keyboard and/or Virtual Keyboard, plurality of memory socket, Radio, GPS, plurality of memory chips, plurality of camera lens, Television, plurality of antenna and so on can operated by CPU (14) in the Camera, Digital Camera, Camcorder and Video Camera.

2) A Camera, Digital Camera, Camcorder, Video Camera and other camera system comprising a mobile phone as claimed in claim (1), wherein, a Camera, Digital Camera, Camcorder, Video Camera and other camera system comprising a mobile phone having one simsocket for accepting one simcard and the function of mobile phone and Camera or Digital Camera or Camcorder or Video Camera is operated by selectively and/or simultaneously by the CPU (Central Processing Unit) (14), switching circuit, transreceivers (15) in the Camera, Digital Camera, Camcorder, Video Camera.

3) A Camera, Digital Camera, Camcorder, Video Camera and other camera system comprising a mobile phone as claimed in claim (1), wherein, the said mobile phone can GSM, CDMA and so on; the said mobile phone can 2G (Second Generation), 3G (Third Generation), 4G (Fourth Generation), 5G (Fifth Generation), 6G (Sixth Generation) and so on.

4) A Camera, Digital Camera, Camcorder, Video Camera and other camera system comprising a mobile phone as claimed in claim (1), wherein, the circuitry of the Camera, Digital Camera, Camcorder and Video Camera contains one simsocket or plurality of simsocket for accepting one simcard or plurality of simcard can transreceive the mobile towers.

5) A Camera, Digital Camera, Camcorder, Video Camera and other camera system comprising a mobile phone as claimed in claim (1), wherein, a mobile phone having a plurality of simsocket contains plurality of pins wherein Input/Output pin, clock pin, reset pin, vcc pin, ground pin are several respective pins of the said simsocket and the said pins of one or plurality of simsocket are connected in parallel and the said plurality of simsocket for accepting plurality of simcards in order to operate selectively and/or simultaneously.

6) A Camera, Digital Camera, Camcorder, Video Camera and other camera system comprising a mobile phone as claimed in claim (5), wherein, the said plurality of simsocket are connected to the CPU (Central Processing Unit) (14) in parallel; the said CPU (14) having the switching circuit and the said CPU (14) is connected to the one or plurality of simsocket through switching circuit; the function of one or plurality of simsocket is operated by the CPU (Central Processing Unit) (14), switching circuit, transreceivers (15).

7) A Camera, Digital Camera, Camcorder, Video Camera and other camera system comprising a mobile phone as claimed in claim (6), wherein, the transreceivers (15) are designed to transreceive the plurality of mobile service providers by selectively and/or simultaneously of the respective plurality of simsocket for accepting plurality of simcards wherein the plurality of simcards contain datas of respective mobile service provider.

8) A Camera, Digital Camera, Camcorder, Video Camera and other camera system comprising a mobile phone as claimed in claim (1), wherein, the function of mobile phone and Camera or Digital Camera or Camcorder or Video Camera is operated by selectively and/or simultaneously by the CPU (Central Processing Unit) (14), switching circuit, transreceivers (15) in the Camera, Digital Camera, Camcorder, Video Camera.

9) A Camera, Digital Camera, Camcorder, Video Camera and other camera system comprising a mobile phone as claimed in claim (1), wherein, the audio of mobile phone can be heard through speakers and/or headphone/earphone jack and/or bluetooth in a Camera, Digital Camera, Camcorder, Video Camera.

10) A Camera, Digital Camera, Camcorder, Video Camera and other camera system comprising a mobile phone as claimed in claim (1), wherein, the features of mobile phone is plurality of bluetooth, plurality of speakers, Wi-fi, SMS, MMS, Video Call, RAM, ROM, Keyboard and/or Virtual Keyboard, plurality of memory socket, Radio, GPS, plurality of memory chips, plurality of camera lens, Television, plurality of antenna and so on can operated by CPU (14) in the Camera, Digital Camera, Camcorder and Video Camera.

11) A Camera, Digital Camera, Camcorder, Video Camera substantially as herein described with respect to the accompanying drawings and description.
